(19) United States
(12) Patent Application Publication
(10) Pub. No.: US 2015/0262362 A1
(43) Pub. Date: Sep. 17, 2015

(54) Image Processor Comprising Gesture Recognition System with Hand Pose Matching Based on Contour Features

(71) Applicant: Avago Technologies General IP (Singapore) Pte. Ltd., Singapore (SG)

(72) Inventors: Denis Vladimirovich Zaytsev, Dzerzhinsky (RU); Denis Vasilyevich Parfenov, Moscow (RU); Dmitry Nicolaevich Babin, Moscow (RU); Aleksey Alexandrovich Letunovskiy, Moscow (RU); Denis Vladimirovich Parkhomenko, Mytyschy (RU)

(21) Appl. No.: 14/645,693

(22) Filed: Mar. 12, 2015

(30) Foreign Application Priority Data
Mar. 12, 2014 (RU) 2014109439

(51) Int. Cl. G06T 7/00; G06K 9/62; G06K 9/00

(52) U.S. Cl. CPC G06T 7/0044; G06K 9/00355; G06K 9/6202; G06T 2207/10004; G06T 2207/30196

(57) ABSTRACT

An image processing system comprises an image processor having image processing circuitry and an associated memory. The image processor is configured to implement a gesture recognition system comprising a contour classification module. The contour classification module is configured to identify one or more hand poses from one or more isolated regions in a first image, to determine a contour of a given one of the one or more hand poses, to calculate one or more features of the contour of the given hand pose, to identify one or more isolated regions in a second image, and to determine whether at least a portion of one or more isolated regions in the second image matches the given hand pose based on a comparison of one or more points characterizing the portion of the one or more isolated regions in the second image and the one or more features of the contour of the given hand pose.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a gesture recognition system comprising a contour classification module. The contour classification module is configured to identify one or more hand poses from one or more isolated regions in a first image, to determine a contour of a given one of the one or more hand poses, to calculate one or more features of the contour of the given hand pose, to identify one or more isolated regions in a second image, and to determine whether at least a portion of one or more isolated regions in the second image matches the given hand pose based on a comparison of one or more points characterizing the portion of the one or more isolated regions in the second image and the one or more features of the contour of the given hand pose.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a contour classification module in an illustrative embodiment.

FIG. 2 is a flow diagram of an exemplary hand pose matching process performed by the contour classification module in the image processor of FIG. 1.

FIG. 3 is a flow diagram of another exemplary hand pose matching process performed by the contour classification module in the image processor of FIG. 1.

FIG. 4 shows an example of pose training FIG. 5 shows an example of pose matching based on contour features.

FIG. 6 shows an example of ambiguous points in an isolated region of an image.

FIG. 7 shows an example of gestures performed on a map application.

FIG. 8 shows an example of a visual representation of an object.

FIG. 9 shows the object in FIG. 8 with lost continuity.

FIG. 10 shows an example of a set of objects for classification.

FIG. 11 shows an example of construction of a table for a subset of points of an object.

FIG. 12 shows an example of contour smoothing without scaling recovery.

FIG. 13 shows an example of contour smoothing with scaling recovery.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves recognizing poses or gestures in one or more images.

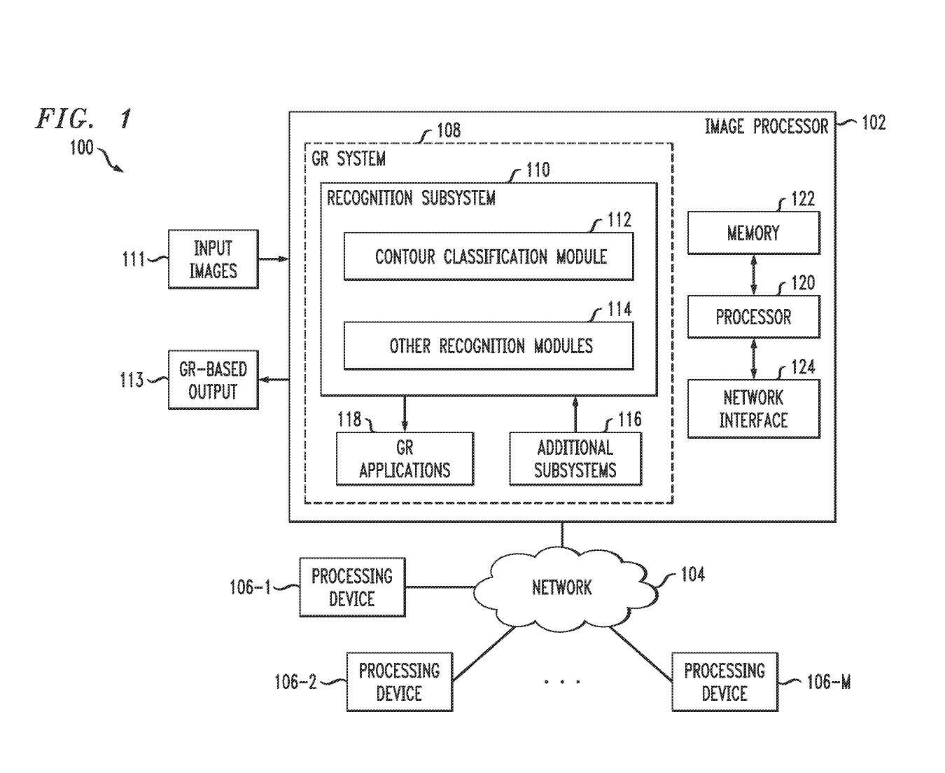

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 110 within a gesture recognition (GR) system 108. The GR system 108 in this embodiment processes input images 111 from one or more image sources and provides corresponding GR-based output 113. The GR-based output 113 may be supplied to one or more of the processing devices 106 or to other system components not specifically illustrated in this diagram.

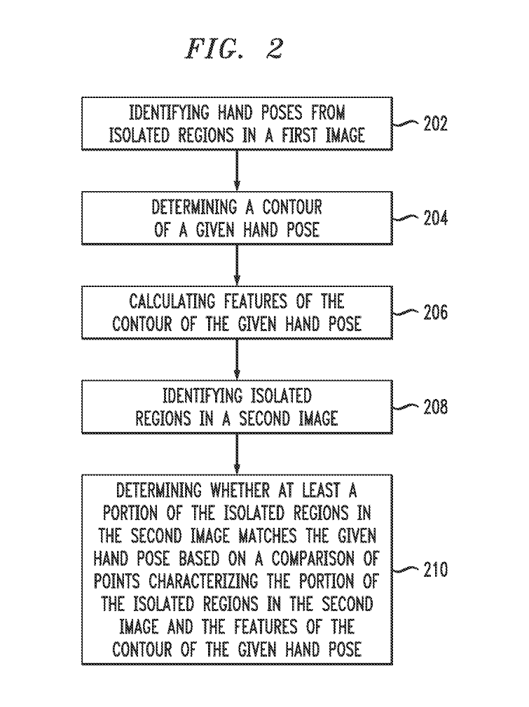

The recognition subsystem 110 of GR system 108 more particularly comprises a contour classification module 112 and one or more other recognition modules 114. The other recognition modules 114 may comprise, for example, respective recognition modules configured to recognize cursor gestures and dynamic gestures. The operation of illustrative embodiments of the GR system 108 of image processor 102 will be described in greater detail below in conjunction with FIGS. 2 through 13.

The recognition subsystem 110 receives inputs from additional subsystems 116, which may comprise one or more image processing subsystems configured to implement functional blocks associated with gesture recognition in the GR system 108, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

Exemplary noise reduction techniques suitable for use in the GR system 108 are described in PCT International Application PCT/US13/56937, filed on Aug. 28, 2013 and entitled “Image Processor With Edge-Preserving Noise Suppression Functionality,” which is commonly assigned herewith and incorporated by reference herein.

Exemplary background estimation and removal techniques suitable for use in the GR system 108 are described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

It should be understood, however, that these particular functional blocks are exemplary only, and other embodiments of the invention can be configured using other arrangements of additional or alternative functional blocks.

In the FIG. 1 embodiment, the recognition subsystem 110 generates GR events for consumption by one or more of a set of GR applications 118. For example, the GR events may comprise information indicative of recognition of one or more particular gestures or poses within one or more frames of the input images 111, such that a given GR application in the set of GR applications 118 can translate that information into a particular command or set of commands to be executed by that application. Accordingly, the recognition subsystem 110 recognizes within the image a gesture from a specified gesture vocabulary and generates a corresponding gesture pattern identifier (ID) and possibly additional related parameters for delivery to one or more of the GR applications 118. The configuration of such information is adapted in accordance with the specific needs of the application.

Additionally or alternatively, the GR system 108 may provide GR events or other information, possibly generated by one or more of the GR applications 118, as GR-based output 113. Such output may be provided to one or more of the processing devices 106. In other embodiments, at least a portion of set of GR applications 118 is implemented at least in part on one or more of the processing devices 106.

Portions of the GR system 108 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 108.

It should be noted, however, that embodiments of the invention are not limited to recognition of static or dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the GR applications 118 may be implemented on a different processing device than the subsystems 110 and 116, such as one of the processing devices 106.

Moreover, it is to be appreciated that the image processor 102 may itself comprise multiple distinct processing devices, such that different portions of the GR system 108 are implemented using two or more processing devices. The term “image processor” as used herein is intended to be broadly construed so as to encompass these and other arrangements.

In some embodiments, the GR system 108 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 108 from the depth sensor may include a stream of frames comprising respective depth images, with each such depth image comprising a plurality of depth image pixels. For example, a given depth image may be provided to the GR system 108 in the form of a matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 113 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 113 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to match hand poses, although the disclosed techniques can be adapted in a straightforward manner for use with other types of gesture recognition processes such as, by way of example, facial gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 112, 114, 116 and 118 of image processor 102. One possible example of image processing circuitry that may be used in one or more embodiments of the invention is an otherwise conventional graphics processor suitably reconfigured to perform functionality associated with one or more of the components 112, 114, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 113 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 110 and 116 and the GR applications 118. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

In some embodiments objects are represented by blobs, which provides advantages relative to pure mask-based approaches. In mask-based approaches, a mask is a set of adjacent points that share a same connectivity and belong to the same object. In relatively simple scenes, masks may be sufficient for proper object recognition. Mask-based approaches, however, may not be sufficient for proper object recognition in more complex and true-to-life scenes. The blob-based approach used in some embodiments allows for proper object recognition in such complex scenes. The term blob as used herein refers to an isolated region of an image where some properties are constant or vary within some defined threshold relative to neighboring points having different properties. Each blob may be a connected region of pixels within an image. Blobs are examples of what are more generally referred to herein as isolated regions of an image.

The use of blobs allows for representation of scenes with an arbitrary number of arbitrarily spatially situated objects. Each blob may represent a separate object, an intersection or overlapping of multiple objects from a camera viewpoint, or a part of a single solid object visually split into several parts. This latter case happens if a part of the object has sufficiently different reflective properties or is obscured with another body. For example, a finger ring optically splits a finger into two parts. As another example, a bracelet cuts a wrist into two visually separated blobs.

Some embodiments use blob contour extraction and processing techniques, which can provide advantages relative to other embodiments which utilize binary or integer-valued masks for blob representation. Binary or integer-valued masks may utilize large amounts of memory. Blob contour extraction and processing allows for blob representation using significantly smaller amounts of memory relative to blob representation using binary or integer-valued masks. Whereas blob representation using binary or integer-valued masks typically uses matrices of all points in the mask, contour-based object description may be achieved with vectors providing coordinates of blob contour points. In some embodiments, such vectors may be supplemented with additional points for improved reliability.

Embodiments may use a variety of contour extraction methods. Examples of such contour extraction methods include Canny, Sobel and Laplacian of Gaussian methods.

Raw images which are retrieved from a camera may contain a considerable amount of noise. Sources of such noise include poor, uniform and unstable lighting conditions, object motion and jitter, photo receiver and preliminary amplifier internal noise, photonic effects, etc. Additionally, ToF or SL 3D image acquisition devices are subject to distance measurement and computation errors.

The presence of additive noise, usually having Gaussian distribution, and multiplicative noise such as Poisson noise leads to low-quality images and depth maps. As a result, contour extraction can result in rough, ragged blob contours. In addition, some contour extraction methods apply differential operators to input images, which are very sensitive to additive and multiplicative function variation and may amplify noise effects. Such noise effects are partially reduced via application of noise reduction techniques. As such, in some embodiments preprocessing techniques which involve low computation costs are used for contour improvement.

As discussed above, blobs may be used to represent a whole scene having an arbitrary number of arbitrarily spatially situated objects. Different blobs within a scene may be assigned numerical measures of importance based on a variety of factors. Examples of such factors include but are not limited to the relative size of a blob, the position of a blob with respect to defined regions of interest, the proximity of a blob with respect to other blobs in the scene, etc.

In some embodiments, blobs are represented by respective closed contours. In these embodiments, contour de-noising, shape correction and other preprocessing tasks may be applied to each closed contour blob independently, which simplifies subsequent processing and permits easy parallelization.

Various embodiments will be described below with respect to contours described using vectors of x, y coordinates of a Cartesian coordinate system. It is important to note, however, that various other coordinate systems may be used to define blob contours. In addition, in some embodiments vectors of contour points also include coordinates along a z-axis in the Cartesian coordinate system. An xy-plane in the Cartesian coordinate system represents a 2D plane of a source image, where the z-axis provides depth information for the xy-plane.

Contour extraction procedures may provide ordered or unordered lists of points. For ordered lists of contour points, adjacent entries in a vector describing the contour represent spatially adjacent contour points with a last entry identifying coordinates of a point preceding the first entry as contours are considered to be closed. For unordered lists of points, the entries are spatially unsorted. Unordered lists of points may in some cases lead to less efficient implementations of various pre-processing tasks.

In some embodiments, contour classification processes are used for classifying objects visible in a frame. In such embodiments, the contour classification processes are well-suited to cases in which objects are intersected or lose their integrity in a series of frames. Objects to be recognized may include hand poses or hand gestures. In some embodiments, contour classification includes training when objects are fully visible and contour point classification when objects are not fully visible. To classify contour points, some embodiments find matching sets of similar triangles or other polygons where the vertices of the triangles or polygons are points on the contour. Various contour refinement and enhancement techniques may be applied to extracted contours. By way of example, contour enhancement techniques include procedures for nonlinear contour smoothing, procedures for removing artifacts using low complexity methods and procedures for contour scale preservation.

The operation of the GR system 108 of image processor 102 will now be described in greater detail with reference to the diagrams of FIGS. 2 through 13.

It is assumed in these embodiments that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

FIG. 2 is a flow diagram of an exemplary hand pose matching process performed by the contour classification module 112 in the image processor 102 in FIG. 1. In step 202, one or more hand poses are identified from isolated regions in a first image. In some embodiments, multiple hand poses may be identified in the first image. As an example, some gestures in the GR system 108 may involve both of a user's hands. In addition to hand poses, one or more other objects may be identified from the isolated regions or blobs in the first image. For example, some GR systems may involve the use of one or more physical objects such as a video game controller.

In step 204, a contour of a given hand pose is determined. Step 204 in some embodiments may include determining a contour for each object or hand pose identified in step 202. Determining the contour of the given hand pose in some embodiments includes one or more of classifying two or more discontinuous isolated regions as the given hand pose, classifying a given portion of one or more isolated regions as the given hand pose by removing an additional portion of one or more isolated regions which intersect the given portion, and classifying one or more isolated regions as the given hand pose where a portion of the given hand pose is not visible in the first image.

Next, features of the contour determined in step 204 are calculated in step 206. As will be described in further detail below, the features may include feature vectors of distances and angles between contour points of the given hand pose.

In step 208, isolated regions in a second image are identified. The second image, for example, may be one in which two separate hand poses in the first image intersect or overlap one another. The FIG. 2 process continues with determining whether at least a portion of one or more isolated regions in the second image matches the given hand pose in step 210. Step 210 is based on a comparison of points characterizing the portion of the one or more isolated regions in the second image and the features of the contour of the given hand pose calculated in step 206. Step 210 may be repeated for each of a number of hand poses or other objects identified from the first image.

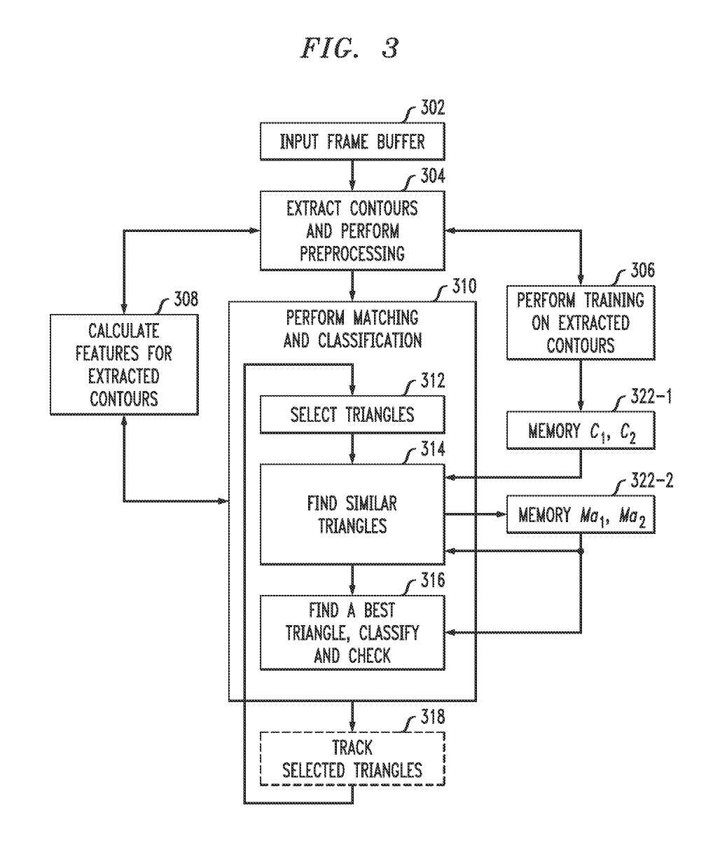

FIG. 3 is a flow diagram of another exemplary hand pose matching process performed by the contour classification module 112 in the image processor 102 of FIG. 1. In block 302, an input frame buffer provides a series of frames or images. In some embodiments, the frames contain data on distances, amplitudes, validity masks, colors, etc. The frame data may be captured by depth, infrared, Red-Green-Blue (RGB) or other color cameras, SL, ToF, various other types of digital cameras, etc.

In block 304, contour extracting and preprocessing operations are performed. Contour extraction provides contours of one or more blobs visible in a given frame. As described above, each blob may represent, by way of example, a separate object, an intersection or overlapping of multiple objects from a camera viewpoint, a part of a single solid object visually split into several parts, or a portion of a solid object partially visible in a given frame.

Examples of preprocessing operations which are performed in some embodiments include application of one or more filters to depth and amplitude data of the frames. Examples of such filters include low-pass linear filters to remove high frequency noise, high-pass linear filters for noise analysis, edge detection and motion tracking, bilateral filters for edge-preserving and noise-reducing smoothing, morphological filters such as dilate, erode, open and close, median filters to remove “salt and pepper” noise, and de-quantization filters to remove quantization artifacts.

In some embodiments, input frames provided by the input frame buffer in block 302 are binary matrices where elements having a certain binary value, illustratively a logic 0 value, correspond to objects having a large distance from a camera. Elements having the complementary binary value, illustratively a logic 1 value, correspond to distances below some threshold distance value. One visible object or hand pose is typically represented as one continuous blob having one outer contour. As will be described in further detail below, however, a single solid object may be represented by two or more blobs in certain instances. In other instances, portions of a single blob may represent two or more distinct objects.

Contour extraction in some embodiments further includes valid contours selection. Valid contours may be selected by their respective lengths. For example, a separated finger should have enough contour length to be accepted, but stand-alone noisy pixels or small numbers of stray pixels should not. In some embodiments, internal contours are also used to represent an object. For example, gray-scale images provide additional internal contours. The contour hierarchy and the relationship to captured objects may also be stored in a memory such as memory 122.

As will be described in further detail below, one or more contour enhancement methods such as distance-dependent smoothing and scale recovery may be performed in block 304 on the extracted contours.

In block 306, training is performed on extracted contours. The training in block 306 is performed on certain ones of the input frames provided by the input frame buffer in block 302. The training block 306 detects conditions for self-training. In some embodiments, this is based on a number of contours in the frame, the localization of contours in the frame, the number of local minimums and maximums of contours in the frame, etc. These values are compared to threshold values, and if the thresholds are met a memory stores the contours from one or more previous frames in block 322-1. FIG. 3 shows two contours C₁ and C₂ which are stored in block 322-1. The particular number of contours resulting from the training block 306, however, may vary and thus embodiments are not limited solely to storage of two contours C₁ and C₂. Instead, more or less than two contours may be stored in block 322-1.

In block 308, features are calculated for extracted contours. The features may correspond to one or more points of an extracted contour. In some embodiments, a subset of a total number of points representing a contour are selected. The order in the sequence of points that form a contour is fixed. The features for the subset of points in an extracted contour include but are not limited to one or more of the following: distance values between a point under consideration, which is referred to as a main point, and each point of the subset of a contour; angles which correspond to the main point and pairs of adjacent points from the selected subset; and local curvatures, convexities and other properties of the main point neighborhood.

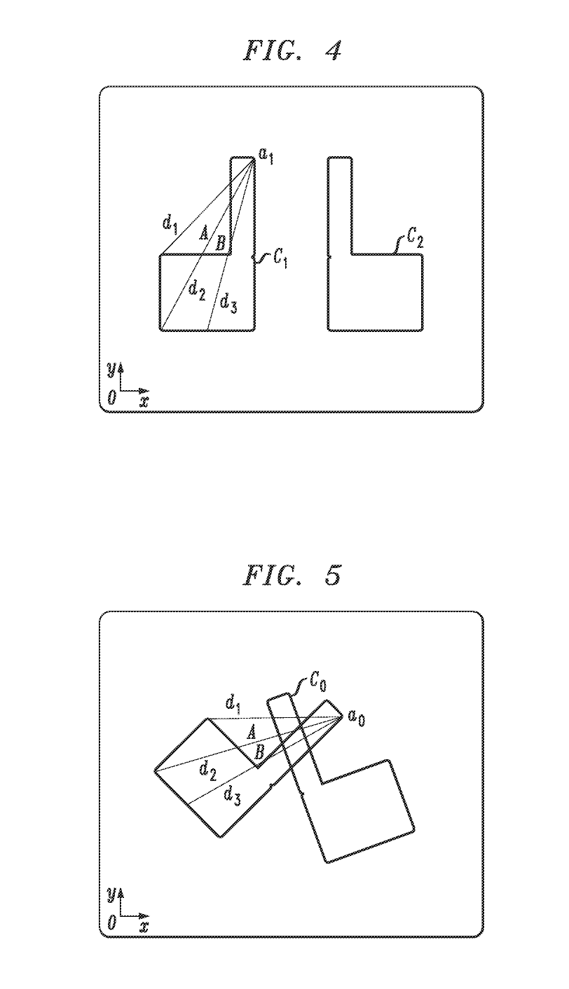

FIG. 4 illustrates an example of features for a given point of a contour for pose training FIG. 4 shows a frame where two clearly distinct objects are represented by two separate blob contours C₁ and C₂. Thus, the frame in FIG. 4 is well-suited for training in some embodiments. In other embodiments, a training frame may show each object as a respective set of multiple blob contours with a known correspondence between blobs in the respective sets. As such, embodiments do not require training frames to have only clearly distinct blobs where each of the distinct blobs represents a separate object as in FIG. 4. Point a₁ in contour C₁ is represented by a set of features including distances d₁, d₂, d₃ and angles A and B. Additional features may be used to increase the reliability of a match between points of different contours.

While not explicitly shown in FIG. 4, each point or a subset of the points in the contours C₁ and C₂ are classified. A first class of points contains those points corresponding to contour C₁ and a second class of points contains those points corresponding to contour C₂. The training block 306 saves the contours C₁ and C₂ in the memory in block 322-1.

The FIG. 3 process continues with block 310, performing matching and classification. The block 310, as will be detailed below, includes selecting triangles in block 312, finding similar triangles in block 314 and finding a best triangle, classifying and checking in block 316. Before describing blocks 312, 314 and 316 in detail, a high-level example of training, matching and classification operations will be described with respect to FIGS. 4-10.

FIG. 5 shows a frame where the contours C₁ and C₂ in the FIG. 4 frame are intersected forming a contour C₀. The matching and classification operation seeks to determine whether contour C₀ matches any of the previously saved contours. In this example, C₀ is checked to determine whether C₀ or some portion thereof matches one or both of saved contours C₁ and C₂. As shown in FIG. 5, the point a₀ in contour C₀ matches the point a₁ in contour C₁ since the contour C₀ contains additional points at distances d₁, d₂, d₃ and angles A and B relative to point a₀. The ordered set of distances d₁, d₂, d₃ and angles A and B are matched to a similar pattern in the contour C₁ but are not matched to a similar pattern in contour C₂. In some embodiments, the ordered set should not match more than one contour for subsequent matching and classification operations. In the FIG. 5 example, point a₀ in contour C₀ matches point a₁ contour C₁ but does not match any point from contour C₂. In some embodiments, contours may change not only position but scale and shape within some threshold range over a series of frames. These complex cases will be described in further detail herein.

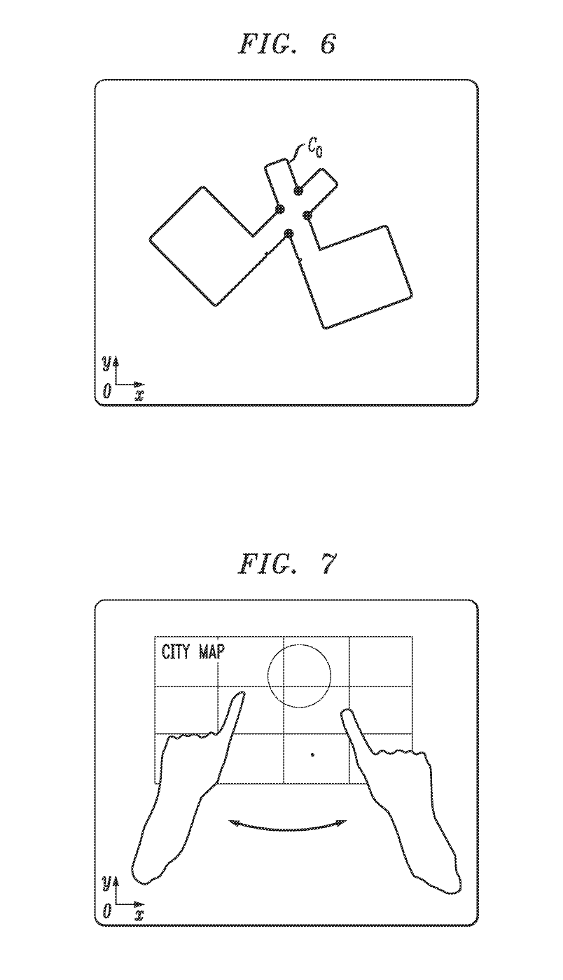

The set of distances d₁, d₂, d₃ and angles A and B for a₀ are an example of a feature vector. This feature vector contains an approximation of a portion of the contour C₀. In some embodiments, finding a threshold number of matching points is a condition for determining whether a portion of contour C₀ matches a saved contour. In the FIG. 5 example, contour C₀ represents an intersection of contours C₁ and C₂. In this case, certain points in the contour C₀ are ambiguous, meaning they belong to both C₁ and C₂. FIG. 6 shows four examples of ambiguous points in C₀ which correspond to contour C₁ and contour C₂.

FIG. 7 shows an example use case of gestures which may be performed on a map application. In FIG. 7, two objects, a left hand and a right hand, maintain their shape during training and classification steps. Well resolvable left and right hand poses are captured together in a sequence of frames. The left and right hand poses are moving while showing some fixed gestures. FIG. 7 shows gestures which may be used for map positioning and zooming. Images of the two hands may occasionally intersect while performing such gestures. Some embodiments allow for separating the left and right hands in order to get their respective positions. In such embodiments, the training block 306 performs training while the hands are visible as separate objects while the matching and classification in block 310 is performed while the hands at least partially overlap one another. In other embodiments, the training block 306 performs training at defined frame intervals, while the matching and classification block 310 propagates the results of point classification in time from frame to frame.

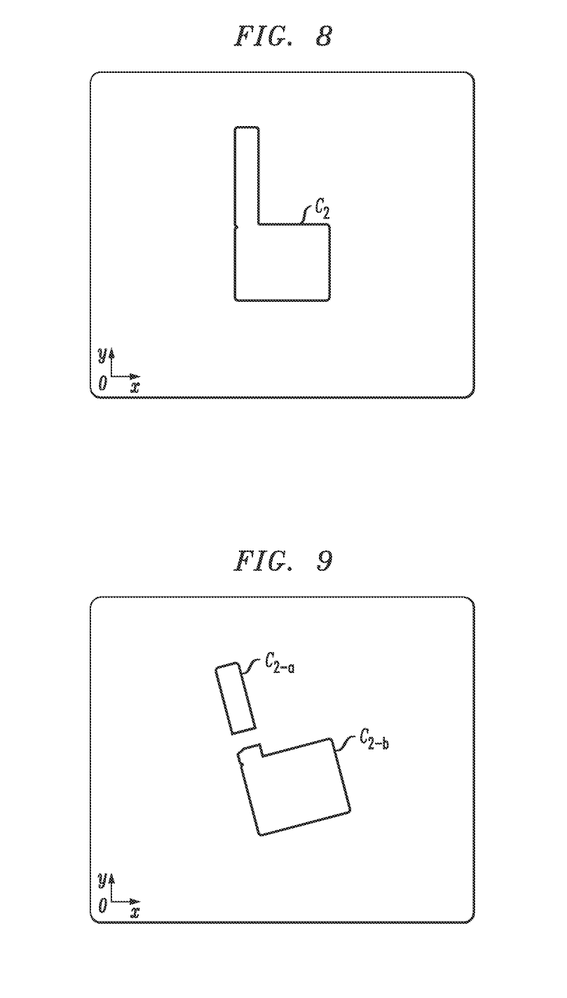

Blocks 304 and 306 may further involve identifying parts of an object such as a hand pose which have lost continuity in one or more frames. Blob connectivity can be lost due to a variety of factors. By way of example, blob connectivity may be lost in one or more frames as a result of temporary overlap with a poorly visible or highly reflective object such as hair or jewelry. As another example, momentary or transient local image noise bursts may cause an object to lose continuity. FIGS. 8 and 9 show respective frames wherein the contour C₂ loses continuity. FIG. 8 shows a frame wherein the contour C₂ is represented by a single blob. FIG. 9 shows a frame where the contour C₂ is represented as two blobs C₂₋ₐ and C_{2-b} due to reflection of a ring on a finger of the hand pose in contour C₂. The training block 306 saves in the memory the continuous contour determined in the contour extraction block 304, and the classification block 310 finds pixels of the contours in the FIG. 9 frame which match the initial contour pixels in the FIG. 8 frame.

It is important to note that while various embodiments are described herein with respect to the contours C₁ and C₂, embodiments are not limited solely to the identification and classification of two objects. Instead, more or less than two objects may be identified and classified in other embodiments. As an example, FIG. 10 shows a frame with contours C₂, C₃, C₄ and C₅.

Returning to the description of the matching and classification block 310, a detailed example of matching a contour will now be described. In the detailed example that follows, the contour C₀ as shown in FIGS. 5 and 6 is the contour to be matched and classified, and the contours C₁ and C₂ saved to the memory in block 322-1. C₀ represents a new contour to be classified from a current frame having a length or number of points N₀. C₁ and C₂ are the first and second contours saved during the training block 306 having respective lengths N₁ and N₂. S₀, S₁ and S₂ represent subsets of the points in the contours C₀, C₁ and C₂, respectively. In some embodiments, S₀ is all the points of the contour C₀. In other embodiments, S₀ is a uniformly distributed subset of the points of the contour C₀, e.g., subdivisions of the points of the contour C₀ with a fixed step. For clarity of illustration in this example, it is assumed that the points in the subsets S₀, S₁ and S₂ are always enumerated in the same order as in the respective contours C₀, C₁ and C₂. In the examples that follow, it is assumed that the points of the contour are enumerated in a counterclockwise direction.

In block 312, a triangle is selected for checking T₀ represents an ordered triple of points (a₀, b₀, c₀) from S₀ that form a triangle. More generally, T₀ may be defined as an ordered set of different points having a size P≧3. T₀ may be selected randomly according to some enumeration of subsets of size P in S₀. Also, T₀ or some points of T₀ may be retrieved from an external source. In some embodiments, some of the points of T₀ may be retrieved as the result of the tracking block 318, which will be described in further detail below. For the triangle T₀, a feature vector may include some or all of the following:

1. a₀—the main point of T₀;

2. b₀ and c₀—reference points from a₀;

3. A₀—the angle (c₀, a₀, b₀);

4. d₀_{_{—}}_{ab}—a distance between a₀ and b₀; and

5. d₀_{_{—}}_{ac}—a distance between a₀ and c₀.

If image scale is changed between frames, the feature vector may include the ratio d₀_{_{—}}_{ab}/d₀_{_{—}}_{ac}. This ratio in combination with the angle A₀ allows for matching of similar triangles when scale changes between frames.

Block 314 finds similar triangles in contours for which it is desired to find a match. For T₀, the task is to find a list L₁ of similar triangles in C₁ and a list L₂ of similar triangles in C₂. In some embodiments, it is assumed that mirrored objects should not be matched and thus similar triangles which are mirror images are excluded. Similarity is selected by detecting substantially equal angles and ratios of corresponding distances. In some embodiments, similarity is detected subject to defined error thresholds. For example, equal angles may be detected up to an error threshold errA and equality among ratios of corresponding distances may be detected up to an error threshold errR for the ratio d₀_{_{—}}_{ab}/d₀_{_{—}}_{ac}. The lists L₁ and L₂ represent candidates for matching which may be further checked using additional points or features in block 316. Additional lists L₃, L₄ and L₅ may be found for contours C₃, C₄ and C₅, respectively.

To find the lists L₁ and L₂ of similar triangles, brute-force approaches are used in some embodiments. In other embodiments, an alternate procedure for finding the lists L₁ and L₂ is used. An example of the alternate procedure will be described below with respect to matching T₀ to contour C₅ to determine the list L₅. Similar procedures may be used for matching T₀ to contours C₁, C₂, C₃ and C₄ to determine the lists L₁, L₂, L₃ and L₄, respectively.

As described above, block 312 selects a triangle represented by T₀ having main point a₀, corresponding angle A₀ and ratio d₀_{_{—}}_{ab}/d₀_{_{—}}_{ac}. A triangle T₅ in C₅ has a main point a₅, a first reference point b₅ and second reference point c₅. There are N₅ possible selections of the main point a₅ in C₅, where N₅ is the number of points or length of the contour C₅. For each selection of a₅ the possibilities for selecting b₅ and c₅ are checked.

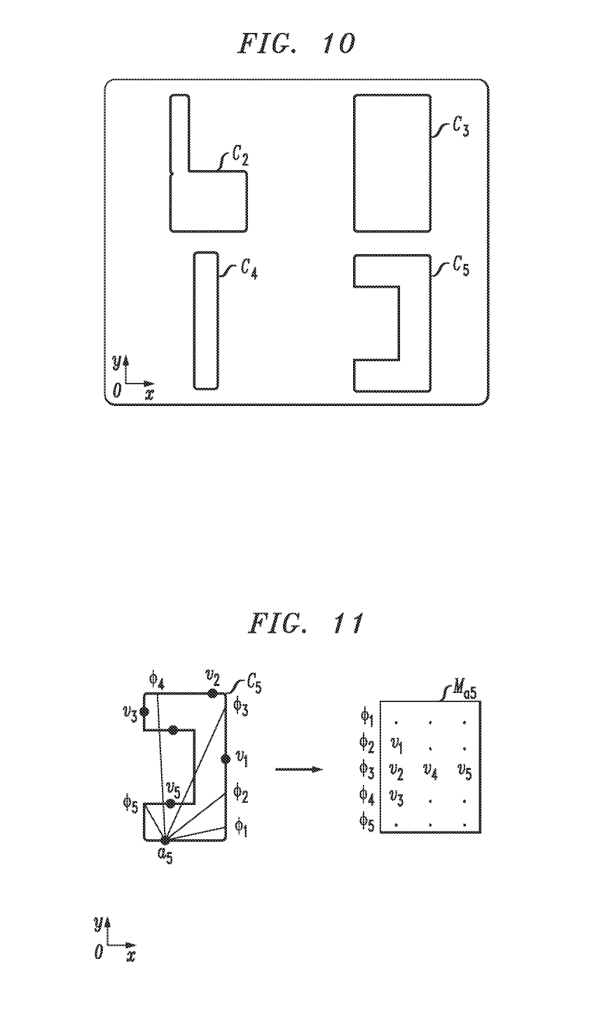

In some embodiments, an alternate procedure is used for finding classes of equivalence of C₅ points. An example of this alternate procedure is shown in FIG. 11. OY represents one axis selected in a Cartesian coordinate system. FIGS. 4-11 show points in a Cartesian coordinate system having x and y axes relative to an origin point O. φ represents angles between a line connecting a₅ and one or more other contour points of C₅ and the axis OY.

FIG. 11 shows construction of a table Mₐ₅ for example points v₁, v₂, v₃, v₄ and v₅ in the contour of C₅ and corresponding angles. FIG. 11 shows a small set of the points and a large step error errA for visibility. The table Mₐ₅ has rows that correspond to angle values from φ to φ_errA. Rays that form the angle begin at point a₅. Each row contains a list of points from C₅ that are located within the given angles φ₁, φ₂, φ₃, φ₄ and φ₅. The number of rows H in the table Mₐ₅ depends on the selected precision errA for an angle. If angles are given in degrees, then H<360/errA+1. K is the number of columns in table Mₐ₅. The number of columns K is equal to the maximum length of the list of points and depends on the contour C₅ geometry and the point a₅ selection. Simple contours like circles have K=1. More complicated contours which have twists and/or straight portions may have K>1 for point a₅.

In some embodiments, the table Mₐ₅ is not changed until the training contour C₅ changes. In these embodiments, recalculation of Mₐ₅ is performed when contour C₅ is used for the first time. Subsequent frames utilize the pre-computed Ma5 stored in a memory. For example, the FIG. 3 process shows tables Mₐ₁ and Mₐ₂ stored in the memory in block 322-2. The tables Mₐ₁ and Mₐ₂ are constructed for points in contours C₁ and C₂ respectively. While not explicitly shown in FIG. 3, the memory may further store a table for each identified contour, including Mₐ₅. Recalculation of the tables in block 322-2 in some embodiments is avoided or performed in rare instances in which objects are starting to intersect one another.

The table Mₐ₅ may be constructed in a single pass though C₅ points or through some subset S₅ of points in the contour of C₅. The pass comprises less than N₅ iterations. The construction of Mₐ₅ is done once for each point from C₅ which may be selected as the main point a₅. In some embodiments, each set of points which having almost equal distances and are located in one row of Mₐ₅ is replaced with a single representative point to reduce the cost of subsequent calculations where Mₐ₅ is used.

To determine the list of similar triangles L₅, the procedure iterates through pairs of rows of Mₐ₅ so that the difference between the corresponding angles φ for the pair of rows is A₀. There are not more than H iterations. For each selected pair of rows there are two sets of reference points relative to the main point a₅. A pair of reference points b₅ and c₅ are selected from the respective sets of reference points to select a current triangle T₅ for checking. The currently selected triangle T₅ comprising points (a₅, b₅, c₅) is checked to satisfy one or more conditions. For example, the points (a₅, b₅, c₅) may be checked to determine if the ratio of distances d₅_{_{—}}_{ab}/d₅_{_{—}}_{ac} matches d₀_{_{—}}_{ab}/d₀_{_{—}}_{ac} within the accuracy threshold errR, where d₅_{_{—}}_{ab} represents the distance between points a₅ and b₅ and d₅_{_{—}}_{ac} represents the distance between point a₅ and c₅. If the conditions are satisfied, T₅ is added to the list L₅. This procedure is repeated for additional triangles of points in contour C₅ to populate the list L₅. The overall procedure is also repeated to populate lists for other contours such as contours C₁, C₂, C₃ and C₄.

In block 316, the best triangle(s) are found, classified and checked. The processing in block 316 will vary depending on current conditions of the lists L₁, L₂, etc. As an example, assume that lists L₁ and L₂ have been created. In a first case, both lists L₁ and L₂ are empty and thus a new triangle T₀ should be selected from contour C₀ in block 312. The first case may occur if the triangle T₀ contains one or more ambiguous points. For example, the first case may occur if one of the ambiguous points of C₀ shown in FIG. 6 is selected as the main point of the triangle T₀.

In a second case, the lists L₁ and L₂ contain one or more candidates. Each candidate is then considered and a best match is selected according to some defined quality metrics. If no candidate matches the defined quality metrics, a new triangle T₀ is selected from the contour C₀ in block 312. The various candidates in lists L₁ and L₂ may be processed as follows. For T₀ and a current candidate triangle T₁ from list L₁, the points a₀, b₀ and c₀ in C₀ which correspond to points a₁, b₁ and c₁ in C₁, respectively, are found. V₁ is the class of such points in contour C₀ that correspond to points in contour C₁.

In some embodiments, an affine transformation and distances are calculated. T represents an affine transformation that transforms T₁ to T₀, such that C₁′=τ(C₁). V₁ is the class of points from C₀ which are found to be close to some points from C₁′ if the current T₁ is assumed as a right match to T₀.

In other embodiments, calculation of affine transformations is not performed and the table Mₐ₁ is used. The current candidate T₁ has a corresponding table Mₐ₁ constructed as described above. The reference points b₁ and c₁ are located in corresponding rows that were found in block 314, which are denoted r_b and r_c respectively. The rows of Mₐ₁ correspond to angles with step error errA. Points in C₀ are processed, starting with point b₀. Let v₀ denote a current point from C₀ and let Aᵥ denote the angle (v₀, a₀, b₀). The row in Mₐ₁ corresponding to angle Aᵥ with respect to r_b is searched. The row number is r_b+(Aᵥ/errA). The current set (a₁, b₁, v₁) is checked to see if it matches one or more conditions such as, for example, whether the ratio of distances d₁_{_{—}}_{ab}/d₁_{_{—}}ₐᵥ matches d₀_{_{—}}ₐᵢ/d₀_{_{—}}ₐᵥ within accuracy errR, where d₁_{_{—}}ₐᵥ represents a distance between point a₁ and v₁ and d₀_{_{—}}ₐᵥ represents a distance between point a₀ and v₀. If this condition is satisfied, then v₀ is added to the list V₁.

The size of V₁, e.g., |V₁|, is used to compare candidates from the L₁ list. In some embodiments, the largest V₁ is stored because it is assumed that the largest size indicates the best match for C₁. V₂ may be similarly calculated for the class of points in contour C₀ that correspond to points in contour C₂. Similarly, the size of V₂ is used to compare candidates from the L₂ list, with the largest V₂ being stored as the best match to contour C₂.

Block 316 in some embodiments includes additional checks. For example, candidates from L₁ which produce good matches with C₁ should not in normal cases produce good matches to C₂ at the same time. Similar checks are performed for L₂ candidates. These additional checks may be performed in a manner similar to that described above for checking V₁ and V₂, although in this case a good match is considered as a restriction violation. If a restriction violation occurs, another triangle T₀ is selected in block 312. If the conditions are satisfied, the best V₁ and V₂ are used as the resulting classification of points in the contour C₀. Again, it is important to note that embodiments are not limited solely to classifying contours C₁ and C₂ but instead are more generally applicable to classifying C₀ or portions thereof to more or less than two contours. In addition, various other conditions may be used in other embodiments in place of or in addition to the above-described conditions.

The FIG. 3 process continues with an optional tracking block 318. Tracking block 318 involves tracking triangles selected in block 312 over a series of frames. The ability to track triangles of points is not required for contour matching and classification in blocks 310-316, but can be used in some embodiments to reduce calculation costs. In the tracking block 318, coordinates of one or more points of triangles selected in block 312 are tracked over a series of frames.

As described above, in some embodiments pre-processing techniques are performed so as to improve contour extraction in block 304 and subsequent matching and classification in blocks 310-316. Such pre-processing techniques include various contour enhancement processes.

In some embodiments, a contour enhancement process involving contour refinement is utilized for pre-processing or refining contours extracted from image frames. Such contour refinement may include obtaining one or more points characterizing one or more blobs in an image, applying distance-dependent smoothing to the one or more points to obtained smoothed points characterizing the blobs, and determining the contour of the given hand pose based on the smoothed points. In some embodiments, applying the distance-dependent smoothing includes at least one of applying distance-dependent weights to respective coordinates of respective ones of the points characterizing the blobs and applying reliability weights to respective coordinates of respective one of the points characterizing the one or more blobs in the first image. Determining the contour of the given hand pose based on the smoothed points may further include applying a scale recovery transformation to the smoothed points so as to reduce blob shrinkage resulting from the distance-dependent smoothing. Two detailed approaches for contour refinement which may be used in some embodiments will now be described.

In a first approach for contour refinement, a square matrix D of distances from each point to every other point in a blob is computed based on a few input vectors. Such a matrix D is useful for classification and contour refinement. To reduce memory usage, zero diagonal elements can be omitted leading to a matrix of (n−1)×(n−1) entries, where n is the total number of contour nodes. Using a Euclidean distance measure in a 3D case, entries in the matrix D may be defined according to the following equation

Dᵢⱼ=\sqrt{(xᵢ−xⱼ)²+(yᵢ−yⱼ)²+(zᵢ−zⱼ)²} (1)

where i and j represent respective points of a blob contour. Entries in D are numerical representations of distances between points. Embodiments are not limited solely to use with Euclidean distance metrics. Instead, various other distance metrics such as a Manhattan distance metric or pseudometrics may be utilized in other embodiments.

Once D is computed, the relative topology of blob points is known. D may then be utilized in some embodiments to make the impact of near points greater than one or more distant points using coordinate weighting. Various approaches may be used to apply coordinate weighting or distance-dependent smoothing. If contour nodes share the same reliability level, coordinate weighting which is sensitive to the distance between selected points and other ones may be applied in an externally linear way according to the following equation

$${\tilde{x}}_{i} = {\sum }_{j = 1}^{n} {x}_{j} {\tilde{w}}_{ij} , {\tilde{y}}_{i} = {\sum }_{j = 1}^{n} {y}_{j} {\tilde{w}}_{ij} , {\tilde{z}}_{i} = {\sum }_{j = 1}^{n} {z}_{j} {\tilde{w}}_{ij} \qquad ( 2 )$$

where normalized weights \tilde{w}ᵢⱼ are in the general case distance-dependent and smoothly decrease as the distance increases. For example, weights may be computed according to the following equation

wᵢⱼ=1/(λ+Dᵢⱼ^{γ}) (3)

and are normalized to the unity according to the following equation

$${\tilde{w}}_{ij} = {w}_{ij} \text{/} {\sum }_{k = 1}^{n} {w}_{ik} \qquad ( 4 )$$

where λ and γ are positive constants. The particular values of the constants λ and γ may be selected based on the constraints of a given system. In some embodiments, 1≦λ≦3, and 1≦γ≦2 are used for high quality weighting.

Despite the easily computed linear form of equation (2), this filtering method is by its nature nonlinear due to the dependence of wᵢⱼ on Dᵢⱼ as shown in equation (3). Far away points produce less impact to the resulting smoothed points \tilde{x}ᵢ, \tilde{y}ᵢ and \tilde{z}ᵢ than nearby points. The resulting effect on the contour data resembles application of a considerably more computationally expensive bilateral filtering approach. The gain in complexity is twofold. First, weights wᵢⱼ can be pre-calculated once and then quickly retrieved on demand depending on quantified Dᵢⱼ values. The quantified Dᵢⱼ values can play the role of an index in the vector of possible w because the weights monotonically depend on distances, which are in turn invariant to exact positions of points in the pair and are sensitive to relative point positions. In equation (1), this is given by Euclidean distance. Second, although coordinates x, y and z are processed independently, the weight set w is the same for each of the coordinates and can be retrieved just once to save memory read cycles.

Normalization in equation (4) implements a partition of unity approach which is in this case dynamic. The weighting function w is generally not the same for different points and instead depends on the location of the points, which helps to achieve better contour de-noising quality.

If integral quality or reliability metrics are available for the contour points, the normalization in equation (4) may be modified to assign higher weights to more reliability defined nodes in the contour. Integral quality or reliability metrics may be obtained using Mahalanobis distance or probabilistic approaches in some embodiments. As an example, for a point (xᵢ, yᵢ, zᵢ), the reliability metric may be a scaled value 0≦rᵢ≦1 such that the higher it is the more reliable contour point coordinates are. In this example, equation (4) is modified as follows

$${\tilde{w}}_{ij} = {w}_{ij} {r}_{j} \text{/} {\sum }_{k = 1}^{n} {r}_{k} {w}_{ik} . \qquad ( {4}^{′} )$$

Equations (4) and (4′) may be further modified based on variances along each coordinate in the tuple (xᵢ, yᵢ, zᵢ). In real-world scenarios, coordinate variation differs. For example, in ToF and SL cameras the resolution in the (x, y) plane perpendicular to the camera's optical axis is not as high as common infrared charge-coupled device (CCD) cameras. In ToF and SL cameras, however, the z-coordinate, e.g., the depth or range, has greater measurement deviation. In this case, gains may be achieved from separately processing channels for the respective coordinates. Thus equation (2) is modified as follows

$${\tilde{x}}_{i} = {\sum }_{j = 1}^{n} {x}_{j} {\tilde{w}}_{xij} , {\tilde{y}}_{i} = {\sum }_{j = 1}^{n} {y}_{j} {\tilde{w}}_{yij} , {\tilde{z}}_{i} = {\sum }_{j = 1}^{n} {z}_{j} {\tilde{w}}_{zij} \qquad ( {2}^{′} )$$

and equation (4′) is modified as follows:

$${\tilde{w}}_{xij} = {w}_{ij} {r}_{xj} \text{/} {\sum }_{k = 1}^{n} {r}_{xk} {w}_{ik} , \\ {\tilde{w}}_{yij} = {w}_{ij} {r}_{yj} \text{/} {\sum }_{k = 1}^{n} {r}_{yk} {w}_{ik} , \\ {\tilde{w}}_{zij} = {w}_{ij} {r}_{zj} \text{/} {\sum }_{k = 1}^{n} {r}_{zk} {w}_{ik} \qquad ( {4}^{″} )$$

where (0≦rₓⱼ≦1, 0≦r_{yi}≦1,0≦r_{zi}≦1) is a tuple of reliabilities for corresponding x, y and z components of positions for jth contour node. Implementation of (2′) and (4″) allows for parallelization, and the computational complexity is proportional to n.

The above-described first approach for contour refinement applies global node smoothing within the same blob. The first approach thus provides sound contour quality, although it involves computation of the complete distance matrix D. Equation (3) ensures fast roll-off of weights wᵢⱼ with departure from ith node. In a second approach for contour refinement, this principle is used for computation economization and locality preservation by summation truncation in equations (2) and (2′). Instead of a sum covering all blob contour nodes, the index range can be restricted in the second approach to some topological vicinity of index distance l on both sides of the current point (xᵢ, yᵢ, zᵢ). Thus, in the second approach, equation (2) is modified as follows

$${\tilde{x}}_{i} = {\sum }_{j = ( i - l ) mod n}^{( i + l ) mod n} {x}_{j} {\tilde{w}}_{ij} , {\tilde{y}}_{i} = {\sum }_{j = ( i - l ) mod n}^{( i + l ) mod n} {y}_{j} {\tilde{w}}_{ij} , {\tilde{z}}_{i} = {\sum }_{j = ( i - l ) mod n}^{( i + l ) mod n} {z}_{j} {\tilde{w}}_{ij} \qquad ( 2 a )$$

and equation (2′) is modified as follows

$${\tilde{x}}_{i} = {\sum }_{j = ( i - l ) mod n}^{( i + l ) mod n} {x}_{j} {\tilde{w}}_{xij} , {\tilde{y}}_{i} = {\sum }_{( i - l ) mod n}^{( i + l ) mod n} {y}_{j} {\tilde{w}}_{yij} , {\tilde{z}}_{i} = {\sum }_{( i - l ) mod n}^{( i + l ) mod n} {z}_{j} {\tilde{w}}_{zij} . \qquad ( {2}^{′} a )$$

In equations (2a) and (2′a), summations are taken around index i, taking into account contour closure which implicates that contour node indexing is cyclical and conveys modular arithmetic. Normalization in equations (4), (4′) and (4″) are also modified to cover indices around i. In the case of equally reliable contour nodes, equation (4) is modified as follows

$${\tilde{w}}_{ij} = {w}_{ij} \text{/} {\sum }_{k = ( i - l ) mod n}^{( i + l ) mod n} {w}_{ik} . \qquad ( 4 a )$$

In the case of coordinate-independent reliability estimates, equation (4′) is modified as follows

$${\tilde{w}}_{ij} = {w}_{ij} {r}_{j} \text{/} {\sum }_{k = ( i - l ) mod n}^{( i + l ) mod n} {r}_{k} {w}_{ik} . \qquad ( {4}^{′} a )$$

In the case of coordinate-dependent reliability estimates, equation (4″) is modified as follows

$${\tilde{w}}_{xij} = {w}_{ij} {r}_{xj} \text{/} {\sum }_{k = ( i + l ) mod n}^{( i + l ) mod n} {r}_{xk} {w}_{ik} , \\ {\tilde{w}}_{yij} = {w}_{ij} {r}_{yj} \text{/} {\sum }_{k = ( i - l ) mod n}^{( i + l ) mod n} {r}_{yk} {w}_{ik} , \\ {\tilde{w}}_{zij} = {w}_{ij} {r}_{zj} \text{/} {\sum }_{k = ( i - l ) mod n}^{( i + l ) mod n} {r}_{zk} {w}_{ik} . \qquad ( {4}^{″} a )$$

In the second approach, computational complexity is a linear function of l≦n. By adjusting l, the second approach can maintain a desired tradeoff between quality and computational burden.

The contour refinement approaches described above allow for removal of contour artifacts attributed to jitter and noise by means of distance-dependent smoothing involving other contour nodes. When applied to a relatively protruding contour node, this smoothing weights the node against other, less protruding nodes. As a result, the blob size or scale is reduced. The amount of blob size reduction depends on the blob shape. In some embodiments, the above-described distance dependent smoothing approaches limit blob shrinkage to a range of 1-6 pixels on each side of the blob while blob shape in general remains the same preserving most relevant features. In other embodiments, however, blob shrinkage may be more severe.

In some embodiments, blob size preservation is useful for subsequent processing or tasks. In these embodiments, even small amounts of blob shrinkage may be undesirable. As an example, blob map topology analysis should utilize highly accurate blob sizes for determining whether to merge a set of adjacent blobs into a blob corresponding to a single object. As another example, automatic blob size normalization for the facilitation of accelerated template matching should utilize highly accurate blob sizes. To meet the demands of such scale-sensitive user cases, blob scale recovery techniques are applied in some embodiments. Such blob scale recovery techniques involve application of scale recovery transformations to the smoothed points so as to reduce blob shrinkage resulting from distance-dependent smoothing. Two detailed examples of such scale recovery transformations will now be described.

In a first approach for scale recovery transformation, the amount of blob shrinkage is estimated by associated area defects. Let BS₀ denote an initial blob size or blob square and let BP₀ denote a blob perimeter. After application of various pre-processing operations including de-noising, distance-dependent smoothing, etc. the resulting blob size and blob perimeter are BS₁ and BP₁, respectively. From geometrical considerations, blob dilation degree (DD) may be estimated in terms of a number of one-pixel layers one needs to “grow” around the blob to restore its original square. This estimation is approximated according to the following equation

DD≈2·(BS₀−BS₁)/(BP₀+BP₁). (5)

For well-defined blobs of sufficient size, perimeter remains nearly the same before and after contour smoothing. In other words BP₀≈BP₁ because the relative square defect 2·(BS₀−BS₁)/(BS₀+BS₁) remains small. This allows estimating the amount of pixels which one needs to “grow” around the blob to restore its original square according to the following equation

DD≈(BS₀−BS₁)/BP₁. (6)

In some embodiments, square correction or scale recovery is achieved using a morphological operation of blob dilation DD times with a minimal structuring element. In other embodiments square correction or scale recovery is achieved by application of an approximately round structuring element of radius DD.

The above-described first approach for scale recovery transformation involves computation of the blob square, and is thus computationally rich. If a computational budget is low, a simplified second approach for scale recovery transformation may be used.

In the second approach, the set of blob contour nodes are split into left-sided and right-sided subsets. In some embodiments, this is accomplished by finding a set of topmost blob points representing g uppermost blob rows and computing the mean or median coordinates ( x̅ₜₒₚ, y̅ₜₒₚ) of the g upmost blob rows, where g is a constant. In a similar manner, the set of lowermost blob points representing the g lowest blob rows are found and their mean or median coordinates ( x̅_{bottom}, y̅_{bottom}) are computed. The blob is split into the left-sided and right-sided subsets with respect to a secant line drawn through the points ( x̅ₜₒₚ, y̅ₜₒₚ) and ( x̅_{bottom}, y̅_{bottom}).

Next, the sum XL₀ of x-coordinates of initial blob contour nodes to the left side of the secant line is computed. The initial blob contour nodes are the points of the blob before application of de-noising and distance-dependent smoothing operations. The sum XL₁ of the de-noised and smoothed blob contour nodes to the left side of the secant line is computed. Corresponding estimates for the respective sums XR₀ and XR₁ of the x-coordinates of the right-sided nodes before and after de-noising and distance dependent smoothing are computed. The dilation degree is then estimated according to the following equation

DD≈(XL₁−XL₀+XR₀−XR₁)/2 (7)

In some embodiments, equation (7) is based in part on inequalities XL₀≦XL₁ and XR₁≦XR₀. These inequalities are valid assuming blob square shrinkage. In other embodiments, equation (7) is based in part on inequality XL₀≦XL₁≦XR₁≦XR₀. This assumption is valid for many representative objects of sufficient size along x-coordinates due to blob square shrinkage.

The second approach for scale recovery transformation is less computationally costly relative to the first approach for scale recovery transformation. Approximate dilation in the second approach, however, is based on the assumptions that blob square correction along the x-axis is more significant than blob square correction along the y-axis and that the blob is convex. These assumptions are valid for most GR applications, as GR objects are typically human hands, human heads or the human body in a vertical position. Blobs corresponding to these objects are characterized by domination of y-size over x-size, which is why reconstruction of the shape proportions along the x-axis is more significant than along the y-axis.

The above-described limiting assumptions used for the second approach in some embodiments are justified by the fairly low computational burden of the simplified dilation algorithm of the second approach. The simplified dilation algorithm involves, for blob contour nodes to the left of the secant line through ( x̅ₜₒₚ, y̅ₜₒₚ) and ( x̅_{bottom}, y̅_{bottom}), correcting their x-coordinate by subtracting DD as calculated in equation (7). For blob contour nodes to the right of the secant line through ( x̅ₜₒₚ, y̅ₜₒₚ) and ( x̅_{bottom}, y̅_{bottom}), correcting their x-coordinate by adding DD as calculated in equation (7).

In some embodiments aspects of the first and second scale recovery transformations may be combined together arbitrarily because the DD square correction values calculated in equations (6) and (7) are defined in a numerically similar way. Moreover, various other techniques for square defect estimation and scale recovery may be applied in other embodiments.

FIG. 12 shows an example of contour smoothing without scaling recovery. In FIG. 12, the bold black line represents the smoothed contour points after application of the first approach for contour refinement with λ=2 and γ=1.5 and application of scale recovery transformation. The gray region of pixels surrounding the bold black line in FIG. 12 represents the initial, noisy contour of the hand pose. FIG. 12 illustrates various defects removed by application of the first approach for contour refinement, as well as area shrinkage resulting from application of the first approach for contour refinement.

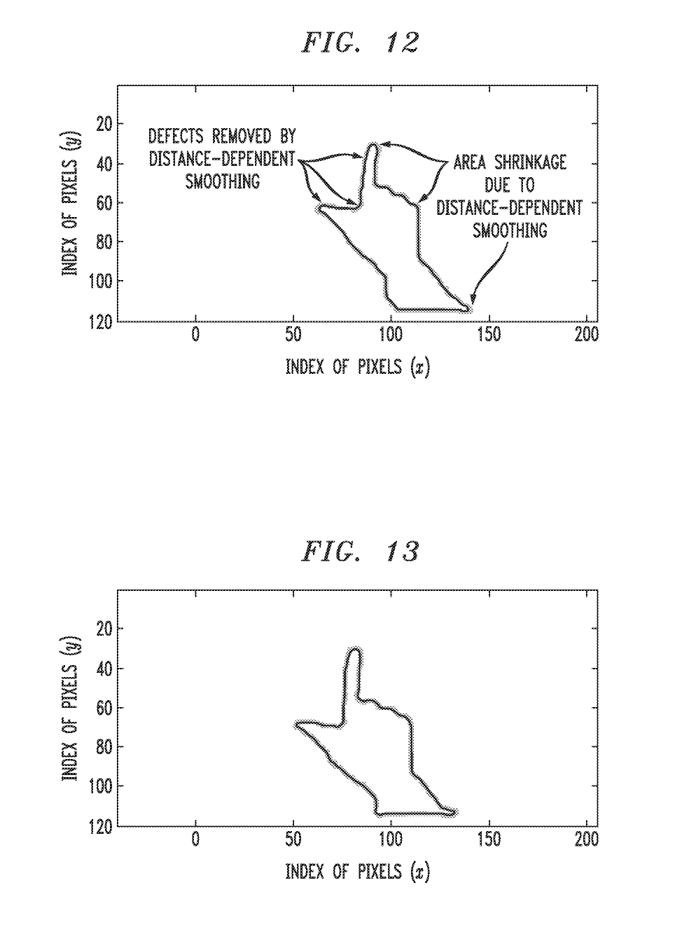

FIG. 13 shows an example of contour smoothing with scaling recovery. In FIG. 13, the bold black line represents the smoothed contour points after application of the second approach for contour refinement with λ=2, γ=1.5 and l=20 and application of the first approach for scale recovery transformation. The gray region of pixels surrounding the bold black line in FIG. 13 represents the initial, noisy contour of the hand pose. The respective x-axes and y-axes of the images in FIGS. 12 and 13 are labeled with indexes of pixels to illustrate scale recovery.

The particular types and arrangements of processing blocks shown in the embodiments of FIGS. 2 and 3 are exemplary only, and additional or alternative steps or blocks can be used in other embodiments. For example, steps or blocks illustratively shown as being executed serially in the figures can be performed at least in part in parallel with one or more other blocks or in other pipelined configurations in other embodiments.

The illustrative embodiments provide significantly improved gesture recognition performance relative to conventional arrangements. For example, these embodiments provide significant enhancement in the computational efficiency of pose or gesture recognition. Accordingly, the GR system performance is accelerated while ensuring high precision in the recognition process. The disclosed techniques can be applied to a wide range of different GR systems, using depth, grayscale, color infrared and other types of imagers which support a variable frame rate, as well as imagers which do not support a variable frame rate.

Different portions of the GR system 108 can be implemented in software, hardware, firmware or various combinations thereof. For example, software utilizing hardware accelerators may be used for some processing blocks while other blocks are implemented using combinations of hardware and firmware.

At least portions of the GR-based output 113 of GR system 108 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

1. A method comprising steps of:
identifying one or more hand poses from one or more isolated regions in a first image;
determining a contour of a given one of the one or more hand poses;
calculating one or more features of the contour of the given hand pose;
identifying one or more isolated regions in a second image; and
determining whether at least a portion of one or more isolated regions in the second image matches the given hand pose based on a comparison of:
one or more points characterizing said portion of the one or more isolated regions in the second image; and
the one or more features of the contour of the given hand pose;
wherein the steps are implemented in an image processor comprising a processor coupled to a memory.

2. The method of claim 1 wherein:
identifying one or more hand poses from one or more isolated regions in the first image comprises identifying the given hand pose and at least one additional hand pose;
determining the contour of the given hand pose further comprises determining a contour of said at least one additional hand pose; and
calculating one or more features of the contour of the given hand pose further comprises calculating one or more features of the contour of said at least one additional hand pose;
further comprising determining whether said portion of the one or more isolated regions in the second image matches said at least one additional hand pose based on a comparison of:
one or more points characterizing said portion of the one or more isolated regions in the second image; and
the one or more features of the contour of said at least one additional hand pose.

3. The method of claim 2 wherein the one or more features of the contour of the given hand pose are calculated for a subset of points characterizing the contour of the given hand pose and the one or more features of the contour of said at least one additional hand pose are calculated for a subset of points characterizing the contour of said at least one additional hand pose; and
further comprising selecting the respective subsets of points of the contour of the given hand pose and the contour of said at least one additional hand pose such that the one or more features of the given hand pose do not overlap the one or more features of said at least one additional hand pose.

4. The method of claim 3 wherein the one or more features of the given hand pose overlap the one or more features of said at least one additional hand pose if a given number of features in respective feature vectors describing respective sets of points of the contour of the given hand pose and said at least one additional hand pose substantially match one another.

5. The method of claim 2 wherein in the first image the given hand pose and said at least one additional hand pose do not intersect one another and in the second image the given hand pose and said at least one additional hand pose intersect one another.

6. The method of claim 1 wherein the one or more features of the contour of the given hand pose comprise, for respective ones of a subset of points characterizing the contour of the given hand pose, an ordered set of distances and angles relating a given point to one or more other points in the respective subset.

7. The method of claim 6 wherein the one or more features further comprise at least one of a local curvature and a convexity among adjacent points of the contour.

8. The method of claim 1 wherein determining whether said portion of the one or more isolated regions in the second image matches the given hand pose comprises:
selecting a feature vector characterizing a first triangle of points in the subset of points characterizing the contour of the given hand pose; and
searching the one or more isolated regions in the second image for a second triangle matching the selected feature vector.

9. The method of claim 8 further comprising repeating the selecting and searching steps for one or more additional feature vectors characterizing additional triangles of points in the subset of points characterizing the contour of the given hand pose.

10. The method of claim 8 wherein the selected feature vector comprises:
an ordered triple of points a₀, b₀ and c₀;
an angle A₀ characterizing (c₀, a₀, b₀);
a distance d₀_{_{—}}_{ab} between a₀ and b₀; and
a distance d₀_{_{—}}_{ac} between a₀ and c₀.

11. The method of claim 10 wherein:
the feature vector further comprises a ratio d₀_{_{—}}_{ab}/d₀_{_{—}}_{ac};
a scale of the first image is different than a scale of the second image; and
the second triangle matches the selected feature vector if A₀ and d₀_{_{—}}_{ab}/d₀_{_{—}}_{ac} substantially match corresponding features A₁ and d₁_{_{—}}ₐᵢ/d₁_{_{—}}_{ac} for an ordered triple of points a₁, b₁ and c₁ of the second triangle.

12. The method of claim 1 wherein determining the contour of the given hand pose comprises:
obtaining one or more points characterizing the one or more isolated regions in the first image;
applying distance-dependent smoothing to the one or more points to obtain smoothed points characterizing the one or more isolated regions in the first image; and
determining the contour of the given hand pose based on the smoothed points.

13. The method of claim 12, wherein applying distance-dependent smoothing to the one or more points comprises applying distance-dependent weights to respective coordinates of respective ones of the points characterizing the one or more isolated regions in the first image.

14. The method of claim 12 wherein applying distance-dependent smoothing further comprises applying reliability weights to respective coordinates of respective one of the points characterizing the one or more isolated regions in the first image.

15. The method of claim 12 wherein determining the contour of the given hand pose based on the smoothed points further comprises applying a scale recovery transformation to the smoothed points so as to reduce isolated region shrinkage resulting from the distance-dependent smoothing.

16. The method of claim 1 wherein determining the contour of the given hand pose comprises at least one of:
classifying two or more discontinuous isolated regions as the given hand pose;
classifying a given portion of one or more isolated regions as the given hand pose by removing an additional portion of one or more isolated regions which intersect the given portion; and
classifying one or more isolated regions as the given hand pose, wherein a portion of the given hand pose is not visible in the first image.

17. (canceled)

18. An apparatus comprising:
an image processor comprising image processing circuitry and an associated memory;
wherein the image processor is configured to implement a gesture recognition system utilizing the image processing circuitry and the memory, the gesture recognition system comprising a contour classification module; and
wherein the contour classification module is configured:
to identify one or more hand poses from one or more isolated regions in a first image;
to determine a contour of a given one of the one or more hand poses;
to calculate one or more features of the contour of the given hand pose;
to identify one or more isolated regions in a second image;
to determine whether at least a portion of one or more isolated regions in the second image matches the given hand pose based on a comparison of: one or more points characterizing said portion of the one or more isolated regions in the second image; and the one or more features of the contour of the given hand pose.

19. (canceled)

20. (canceled)

21. The apparatus of claim 18 wherein the one or more features of the contour of the given hand pose comprise, for respective ones of a subset of points characterizing the contour of the given hand pose, an ordered set of distances and angles relating a given point to one or more other points in the respective subset.

22. The apparatus of claim 21 wherein the one or more features further comprise at least one of a local curvature and a convexity among adjacent points of the contour.

23. The apparatus of claim 18 wherein the one or more features of the contour of the given hand pose are calculated for a subset of points characterizing the contour of the given hand pose.
